(19) United States
(12) Patent Application Publication
(10) Pub. No.: US 2007/0201684 A1
(43) Pub. Date: Aug. 30, 2007

(54) CALL CENTER ROUTING SYSTEM AND METHOD

(76) Inventor: ALTAF BOGHANI, bloomingdale, IL (US)

Correspondence Address: LAMPEL & ASSOCIATES, P.C., 555 SKOKIE BLVD., SUITE 500, NORTHBROOK, IL, 60062, US

(21) Appl. No.: 11/307,514

(22) Filed: Feb. 10, 2006

(51) Int. Cl. H04M 1/00; H04M 3/00

(52) U.S. Cl. 379/360

(57) ABSTRACT

The present invention generally provides a call center system which matches a user to an agent based on, for example, skills, performance ratings, availability and/or other factors. The agent of the call center system may provide a wide variety of information to the user such as, for example, restaurant reviews, movie times, sports scores, news, directions or any other information readily available on, for example, the Internet. After the user is finished with the call, the user may answer a survey relating to, for example, the performance of the agent. The answers to the survey may provide an attribute to a ranking system for the agent which may be used to determine if and when an agent is to receive future calls from the same or other users. The user may also contact the call center system by, for example, an email, a fax, an instant message, a letter or other form of communication.

The present invention generally provides a call center system which matches a user to an agent based on, for example, skills, performance ratings, availability and/or other factors. The agent of the call center system may provide a wide variety of information to the user such as, for example, restaurant reviews, movie times, sports scores, news, directions or any other information readily available on, for example, the Internet. After the user is finished with the call, the user may answer a survey relating to, for example, the performance of the agent. The answers to the survey may provide an attribute to a ranking system for the agent which may be used to determine if and when an agent is to receive future calls from the same or other users. The user may also contact the call center system by, for example, an email, a fax, an instant message, a letter or other form of communication.

It is common for businesses to have routing systems when customers call. For example, a person calling a department store is often required to press a button corresponding to the specific department he or she wishes to be connected with. To the dismay of many, the person may further have to refine the selection within the department. In other systems, the call is routed based on voice recognition technology.

After the person reaches the proper, or commonly improper, department the person is often either connected to a live customer service representative or hears a recorded message. Hopefully, the recorded message or live customer service representative provides the person with the desired information.

Common existing call center systems often utilize digital switching systems. More specifically, these call center systems may use an automatic call distributor (ACD) server or system and or an interactive voice response (IVR) system.

U.S. Pat. No. 6,763,104 to Judkins discloses a method and system for routing calls to individual agents within a call center. The '104 patent allows routing to agents having particular skills and or proficiencies. Further the '104 patent discloses a system in which skills data is input, including a listing of skills and proficiency levels for each skill, via an automatic call distributor (ACD) manager having graphical user interface (GUI). Agents are set up and are used within the call center. The set up occurs by listing each agent via the ACD manager and selectively mapping skills to each individual agent and corresponding to what types of skills that agent possesses. The call is then received within the call center. A requested type of service is determined for the call to determine what skills are required for answering the call. The call is then routed to the proper agent.

However, these existing call center routing systems and methods lack the features of the present invention. More specifically, these existing call center routing systems and methods lack a system for ranking an agent and accordingly connecting an agent to a user based on a ranking system.

A need, therefore, exists for a call center system in which a user can easily, quickly and effectively obtain information from, for example, an agent connected to a computer network such as the Internet. In addition, a need exists for a call center system which matches an agent with a user based on, for example, previous user ratings of the agent.

### SUMMARY OF THE INVENTION

The present invention generally provides a call center system which matches a user to an agent based on, for example, skills, performance ratings, availability and/or other factors. The agent of the call center system may provide a wide variety of information to the user such as, for example, restaurant reviews, movie times, sports scores, news, directions or any other information readily available on, for example, the Internet. After the user is finished with the call, the user may answer a survey relating to, for example, the performance of the agent. The answers to the survey may provide an attribute to the ranking system for the agent which may be used to determine if and when an agent is to receive future calls from the same or other users. The user may also contact the call center system by, for example, an email, a fax, an instant message, a letter or other form of communication.

Everyday millions of users connect to the Internet for information and/or entertainment. In fact some information can only be accessed by the Internet. Further many businesses offer information only on their website. As the number of websites increases everyday, so to does our reliance on the Internet.

If not merely convenient, it is often critical to get information instantly. Often a person who relies on the Internet for information does not have access to the Internet. For example, if that person is shopping or driving that person may often try to call a friend or family member to look something up on the Internet. A problem often arises in that the person the user calls may not be familiar with the subject of the information which he or she must look up. As a result, the person unfamiliar with the subject may often have to spend a great deal of time searching for the proper information on the Internet. Alternatively, the person needing the information may not be able to contact a friend or family member who has access to the Internet.

Although it is know to provide a call center system which provides a wide variety of information to its users, such systems lack a ranking system as disclosed in the present invention. More specifically, they lack a system in which the users have some control over selecting the best possible agent in which to provide them with information.

It is, therefore, an advantage of the present invention to provide a call center system which overcomes the deficiencies of other known call center systems. More specifically, the call center system of the present invention connects the user to the best available agent to answer the user's question.

Further, it is an advantage of the present invention to provide a ranking system for the agents of call center system.

It is a further advantage of the present invention to provide a call center system which allows the user to respond to a survey on the performance of the agent.

A further advantage of the present invention is to provide a call center system which, in part, determines which agent receives a call based on user ranking surveys.

And another advantage of the present invention is to provide a call center system which allows the user to pay on a call-per-call basis.

Another advantage of the present invention is to provide a call center system which allows the user to pay for the call center system services based on a specific time period such as, for example, by the month.

Yet another advantage of the present invention is to provide a call center system which allows a user to submit a wide variety of questions via telephone, the Internet, fax, letter or other means to a central/distributed call center system.

Still another advantage is to allow the call center system to evaluate agent performance based on user input and to determine if an agent is entitled to continue to receive calls.

Still another advantage of the present invention is to provide a call center system which allows a user to submit a wide variety of questions in which an agent may respond at a later point in time.

For a more complete understanding of the above listed features and advantages of the call center system, reference should be made to the following detailed description of the preferred embodiments and to the accompanying drawings. Further, additional features and advantages of the present invention are described in, and will be apparent from, the detailed description of the preferred embodiments and from the drawings.

### BRIEF DESCRIPTION OF THE DRAWINGS

FIG. 1 is a flow chart showing one embodiment of the present invention.

FIG. 2 is a block diagram showing one embodiment of the selection process for an agent.

FIG. 3 is a block diagram showing one embodiment of the possible user information stored in a user database.

FIG. 4 is a block diagram of one embodiment of the possible communication means of the present invention.

FIG. 5 is an example chart illustrating possible scores for an agent of the present invention.

### DETAILED DESCRIPTION OF THE PREFERRED EMBODIMENTS

The present invention generally provides a call center system which matches a user to an agent based on, for example, skills, performance ratings, availability and/or other factors. The agent of the call center system may provide a wide variety of information to the user such as, for example, restaurant reviews, movie times, sports scores, news, directions or any other information readily available on, for example, the Internet. After the user is finished with the call, the user may answer a survey relating to, for example, the performance of the agent. The answers to the survey may provide an attribute to a ranking system for the agent which may be used to determine if and when an agent is to receive future calls from the same or other users. The user may also contact the call center system by, for example, an email, a fax, an instant message, a letter or other form of communication.

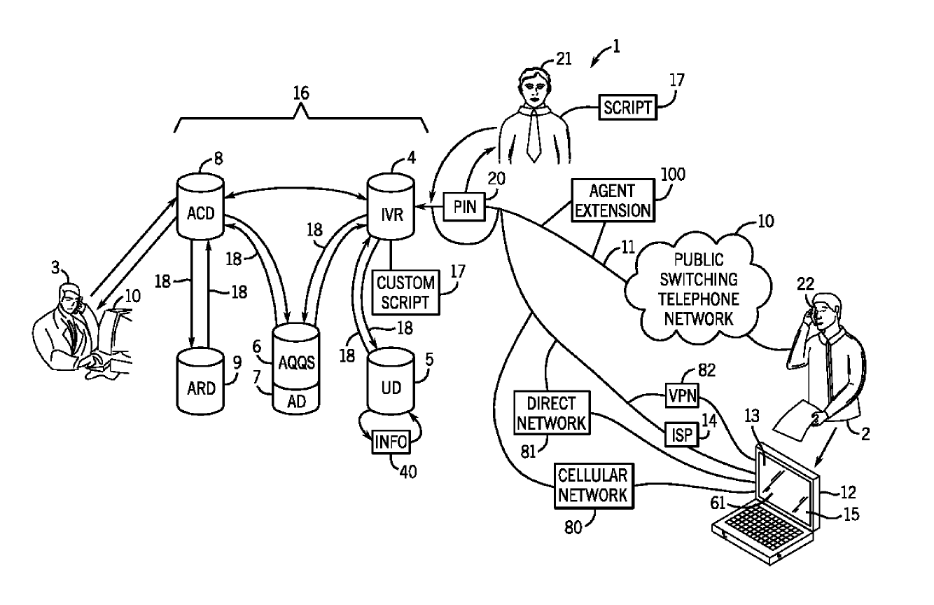

Referring now to the drawings wherein like numerals refer to like parts, FIG. 1 illustrates a call center system 1 utilizing an example embodiment of the present invention. In this example embodiment, a user 2 may employ a public switched telephone network 10, cellular network, direct network or VPN (FIG. 1 illustrates a public switched telephone network). The call from the user 2 may enter the call center system 1 by, for example, an incoming trunk 11. However, the user 2 may also utilize, for example, a computer 12 to access a computer network such as, for example, the Internet 13. If the user 2 utilizes a computer 12, the computer 12 may be connected to an Internet service provider 14, cellular network 80, direct network 81 or VPN 82. In addition, the computer 12 may have an appropriate operating system 15, such as, for example, MicroSoft Windows®, or a browser such as, for example, Internet Explorer®.

The hardware 16 for the call center system 1 may be located, for example, at a central location or may be located at various locations. The figures illustrate the hardware 16 located at a central location (except for the hardware of a user 2 and an agent 3). The agent 3 may be, for example, an independent contractor or the agent 3 may be an employee of the company operating the call center system 1.

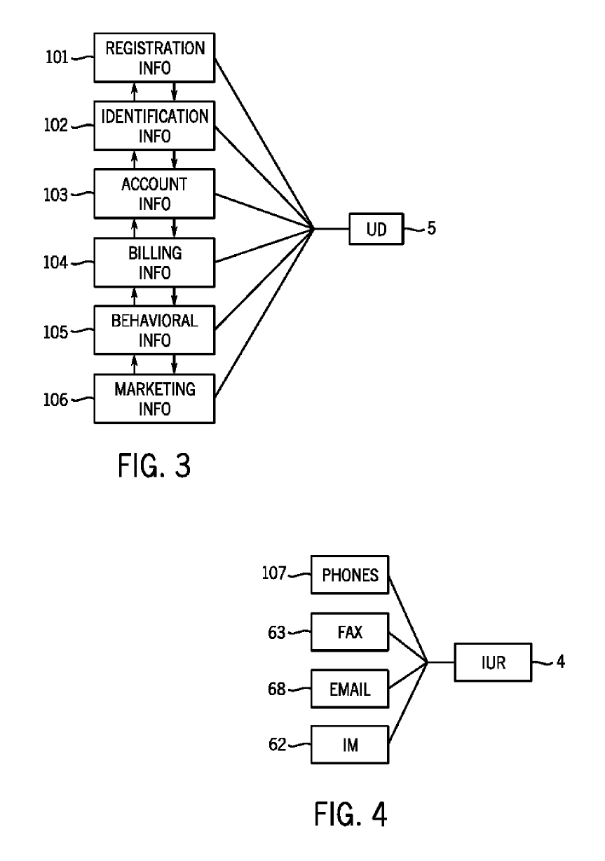

The call center system 1 may have, for example, an interactive voice response (IVR) 4. The IVR 4 may be a computer which may, for example, include or communicate to a user database (UD) 5 that stores user 2 registration information 101, identification information 102, account information 103, billing information 104, behavioral information 105, marketing information 106 and the like (as illustrated in FIG. 3). Further, the IVR 4 may be, for example, the first component in the call center system 1 in which the user 2 is connected to when the user 2 places a call. Alternatively, the user 2 may contact a live customer service representative 21 of the call center system 1. The customer service representative 21 may direct the call of the user 2 to the appropriate agent 3.

The IVR 4 may, for example, gather information from the user 2 before the user 2 speaks with a live agent 3. In addition the IVR 4 may guide the user 2 through a custom script 17. The IVR 4 may be completely integrated with an automatic call distributor (ACD) 8 and or the AQQS 6 (as later described), transferring calls to the appropriate component of the call center system 1. If the user 2 does not need to speak to a live agent 3, the IVR 4 may be automatically programmed to respond via fax 63, instant messaging 62 or email 68 (as illustrated in FIG. 4); or the call center system 1 may be programmed to announce user 2 information, such as, the user's 2 balance or other status.

The IVR 4 may be in communication with a user database (UD) 5. More specifically, the IVR 4 may be in communication with the UD 5 by, for example, a TCP/IP link 18. The communication may be bidirectional. It should be understood that all communication between components of this system may be bidirectional and may be by, for example, TCP/IP links 18. The UD 5 may authenticate a user 2 as a customer of the call center system 1. If the user 2 is authenticated as a customer the call may then be passed back to the IVR 4.

Calls that proceed from the IVR 4 may be feed to the agent qualifying and queuing system (AQQS) 6. The AQQS 6 may, for example, receive user 2 preferences from the IVR 4. More specifically, the AQQS 6 may have a database which matches specific types of requests with specific agents. The AQQS 6 may be in communication with an agent database (AD) 7. The AD 7 may be, for example, a database containing all the agents 3 authorized to respond to queries by users 2 of the call center system 1. The AD 7 may also have a database of all the agents 3 who are presently active within the call center system 1.

In communication with the AQQS 6 and/or the AD 7 may be the ACD 8. The ACD 8 may, for example, automatically select the proper agent 3 to answer the call from the user 2 based on several factors. The ACD 8 may be, for example, a centralized computer database located, for example, within a building of the company providing the call center system 1. The ACD 8 may electronically communicate with, for example, the agent 3.

In addition to the agent 3, the ACD 8 may be in communication with an accounting and reporting database ARD 9. The ARD 9 may, for example, record information relating to the call. More specifically, the ARD 9 may record, for example, the length of the call, the user 2 identification, any internet sites 10 visited by the agent 3 and/or any charges which may be deducted from the user's 2 account.

The basic call flow of an embodiment of the present invention is as described as follows with references to FIGS. 1-6.

An agent 3 connects to the call center system 1. The agent 3 may be, for example, an independent contractor or a salaried employee. Further, the agent 3 may work out of his or her house or may be located at an office. Even further, the agent 3 may be free of a specific location and free to operate from different locations.

The user 2 makes a call to a designated number(s), such as a 800, 877, 900 or 976 number, thereby contacting the call center system 1. The call may require a toll or may be toll free. In some embodiments, the user 2 may have a predetermined personal identification number (PIN) 20 in which the user's 2 account 40 is debited according to a charge associated with the call. More specifically, the user 2 may be charged a flat rate per call or may be charged based on usage, for example, the time taken to respond to the user's 2 request. Alternatively, a user 2 may be charged a flat rate for a specified period of time.

The user 2 may, for example, make a request to a general customer service representative 21 or may enter keys on a telephone 22 in response to automated questions. The request may be, for example, for the call center system 1 to tell the user 2 what time a restaurant is open until.

The call center system 1 may route the user 2 to an appropriate agent 3 based on a predetermined score the call center system 1 has assigned to the agent 3. The user 2 may be transferred to the agent 3 with the highest predetermined score or aggregation of scores.

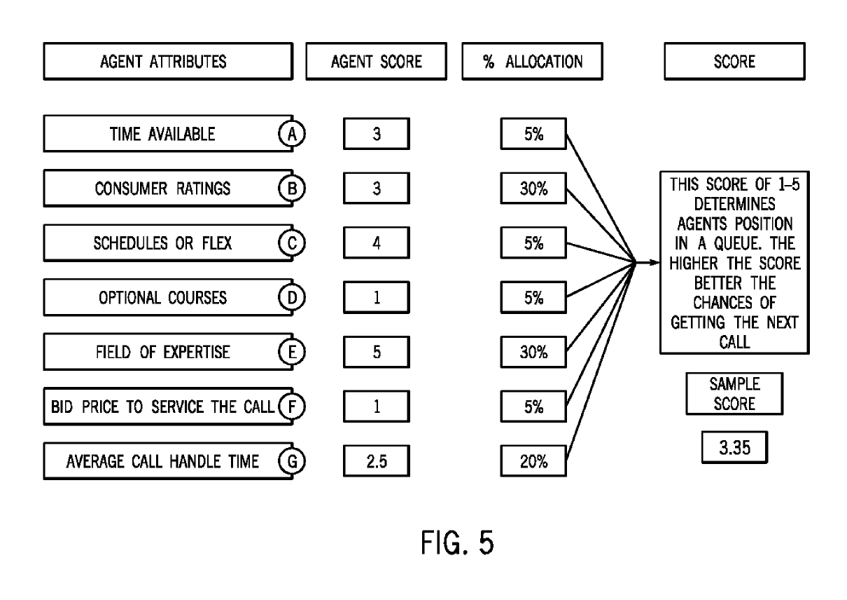

The agent 3 the call is transferred to depends on a number of different factors. The first factor which may be considered when the agent 3 is chosen to answer the user's 2 call may be the time availability 70 of the agent 3. More specifically, the agent 3 may commit, ahead of time or at the time in which the agent 3 connects to the call center system 1, his or her time availability. For example, the agent 3 may commit to take calls from, for example, 3 to 4 p.m. The call center system 1 may assign a point value based on the amount of time 30 (as illustrated in FIG. 5) the agent 3 indicates he or she is available. For example, if an agent 3 is available for 15 minutes, the agent 1 may receive a score of 1 point whereas an agent 3 who commits to a 3 hour time period may receive 5 points. It should be understood that the amount of time and point value may vary depending on the call center system 1 requirements.

In addition to the amount of time the agent 3 commits to the call center system 1 may assign a point value based on previous user's 2 ratings 31. For example, after each call the user 2 may elect to rate the agent 3 on a scale from, for example, 1 to 5. The agent's 3 average rating 31 is updated after each call or at a scheduled time in which a user 2 rates the agent 3. The rating 31 process may, for example, simply ask the user 2 to type in a score of 1 to 5 for the entire process or may break up the rating 31 into a series of rating 31 questions for the user 2 to answer. The rating 31 system may be optional for the user 2.

The agent 3 may have one of two types of schedules, either planned 32 or flex 33. In a planned 32 schedule the agent 3 commits ahead of time when he or she is available to answer calls. In the flex 33 schedule, the agent 3 may simply connect to the call center system 1 to wait and see if any calls come in which fit the agents 3 field of expertise 79. The call center system 1 may assign a different point value for planned 32 and flex 33 schedules. For example, a planned 32 schedule may receive a higher point value from the call center system 1 than a flex 33 schedule. In addition, an agent 3 may be given a call even if the agent 3 is not an expert in the topic. More specifically, the agent 3 may be given a call if the agent's 3 rating 31 is high enough and or if few agents 3 are available to answer calls.

In addition to schedule, user rating and other factors, the agent 3 may receive a rating based on, for example, the number and/or type of courses 34 taken by the agent 3. For example, an agent 3 who is qualified to receive calls in the area of home repair may take courses 34 in home repair. The courses 34 may be available, for example, on-line, over the phone, live courses or taped courses. Further the courses 34 may be, for example, available to the agent 3 while the agent 3 waits to receive calls from the call center system 1. The courses 34 may be optional or may be required. The call center system 1 may be set up so that, for example, every 5 courses the agent 3 completes the agent moves up a ranking point. The ranking point may be, for example, on a scale from 1 to 5.

The agent 3 may also be ranked based on the area of expertise of the agent 3. For example, an agent may be ranked higher in a field, such as, directions, restaurants, wines, etc, than in the fields of, for example, movies, sports or books. The agent 3 may be ranked differently in any number of fields based on, for example, the agents 3 own indication, and/or the user's 2 ratings. Further, the agent 3 may be ranked differently in any number of fields based a determination by the company providing the call center system 1. The company may, for example, require the agent 3 to take an exam in any field in which the agent 3 wishes to be qualified to receive calls from. Preferably, the better the match with the user preference input into the IVR 4, the better the agent's 3 score.

The agent 3 may also be ranked based on the average handling time 120 the agent 3 takes to provide the user 2 with the requested information. For example, an agent 3 who averages ten minutes handling a call may receive a ranking of 1 point whereas an agent 3 who averages two minutes handling a call may receive a ranking of 5 points. Of course, the call center system 1 may be set us so that the point value may vary. Preferably, the shorter the average call handling time the better the ranking point score.

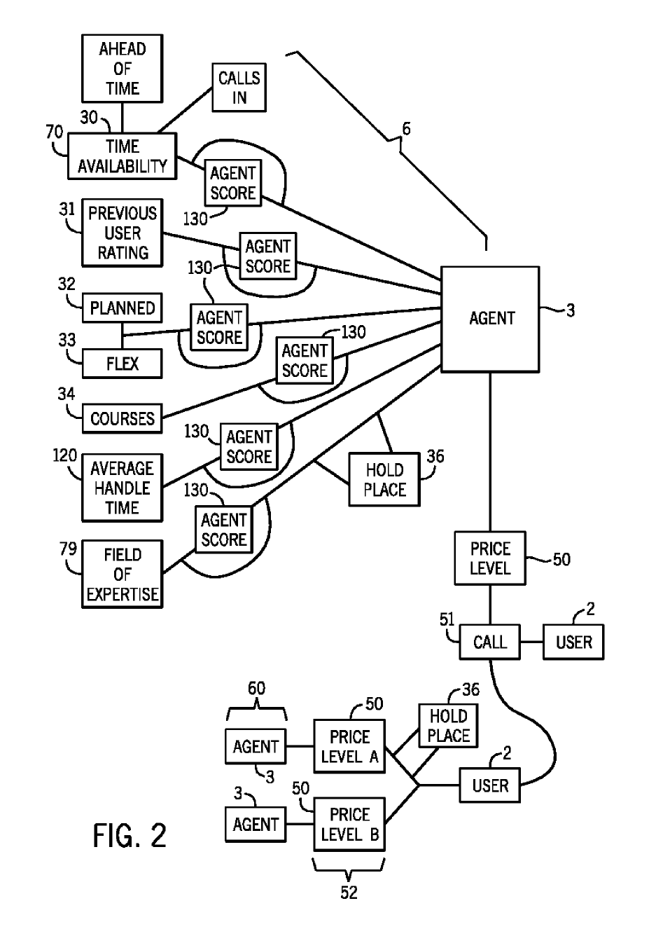

The agent 3 may be able to set a price level 50 for which the agent 3 is willing to accept a call 51 from a user 2 and respond appropriately to the user 2. More specifically, agent 3 may, for example, bid 52 a price 50 level for which the agent 3 is willing to accept the call 51 from the user 2 for that session or day. If two or more agents 3 bid 52 for a call 51, the agent 3 with, for example, the lowest price level 50 may receive the call 51. The price level 50 the agent 3 determines may remain confidential or may be viewed by other agents 3 and/or potential users 2. The agent 3 may input his or her bid into the ACD 8 or AQSS 6 by, for example, typing the bid 52 into his or her computer or the agent 3 may contact a customer service representative 21 and inform the customer service representative 21 of his or her bid 52. For example, if agent A bids $2.00 a call and agent B bids $1.75 a call, the call may be directed to agent B. The agent's 3 bid 52 may be the controlling factor in determining which agent 3 receives a call 51 from the user 2 or the agent's bid 52 may be one of many factors determining which agent 3 may receive a call 51. FIG. 2 illustrates examples of factors which may determine which agent 3 is to receive a call 51 from the call center system 1. The list of factors illustrated in FIG. 2 are just examples of factors which may be used to determine which agent 3 is to receive a call 51. It should be understood that other factors may be used to determine which agent 3 is to receive a call 51.

If no agents 3 in a specific area of expertise 79 are available, or if a specific requested agent 3 is not available, the call center system 1 may allow a user to hold their place 36 in line until the appropriate agent 3 is available. The user 2 may then do other things while waiting to be called back by the agent 3.

The agent 3 may also be rated based on the average handle time 120 it takes for the agent 3 to provide the user 2 with the requested information. For example, if the average handle time 120 is higher than normal, the agent 3 may have a reduced agent score 130. The reduced agent score 130 may lower the chances of the agent 3 being connected to future calls from the call center system 1. More specifically, if two agents 3 are available, the agent 3 with the higher agent score 130 may receive the call from the user 2.

When the call is transferred to a specific agent 3, the agent 3 may be given information regarding the user 2. More specifically, the agent 3 may access information regarding the user 2 from the UD 5. Information stored in the UD 5 regarding the user 2 may reduce the amount of time needed for the agent 3 to respond to the request of the user 2. For example, if the user 2 previously placed a call to the call center system 1 regarding, for example, the name of a restaurant at a specific location, the agent 3 may be able to provide the name of the restaurant in less time. If the agent 3 who receives a call from the user 2 is unable to assist the user 2, the agent 3 may redirect the user 2 back to the IVR 4 or may redirect the user 2 to another agent 3.

After the user 2 has terminated the call with the agent 3, the user 2 may be given the option of responding to a survey ranking 31 the performance of the agent 3. The user 2 may also be given an agent extension 100 corresponding to the agent 3. The user 2 may elect to enter the agent extension 100 into the call center system 1 to contact the same agent 3 at a later time. As a result, the agent extension 100 may allow the user 2 to contact an appropriate agent 3 without the frustration of being routed through unnecessary transfers. This feature is useful if the user 2 finds an agent 3 helpful in a field of expertise in which the user 2 is likely to call again regarding.

A user 2 may be able to designate preferred agents 3 to be connected to prior to the call center system 1 matching the user 2 to an agent 3 with, for example, the AQSS 6. For example, a user 2 may designate he or she wishes to be connected with an agent 3 with no less than a rating of 3.5. Further, the user 2 may designate he or she wishes to be connected with an agent 3 within a designated group 60 of agents 3. For example, the user 2 may designate the agent(s) 3 by indicating his or her preferences on a call center system 1 website 61. Further, a user 2 may designate a specific agent 3 by inputting the specific agent's 3 extension 100 (FIG. 1) into the call center system 1, by telling a customer service representative 21, by communicating with the call center system 1 through instant messaging 62, fax 63, email 68, phones 107 or any other means of communication. The user 2 may also indicate what attributes matter most to him or her. For example, the user 2 may be primarily concerned with price or expertise in a field.

Finally, the ARD 9 may debit the user's 2 account for the appropriate cost for the call.

Thus, as described above, embodiments of the present invention provide consumers with a reliable, secure, and convenient method for obtaining information from a call center system.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

What is claimed is:

1) A method for using a call center system comprising:
providing an interactive voice response system wherein a user inputs data into the interactive voice response system;
providing a user database wherein the user database contains information relating to the user and wherein the user database is in communication with the interactive voice response system;
providing an agent qualifying and queuing system wherein the agent qualifying and queuing system is in communication with the interactive voice response system and further wherein the agent qualifying and queuing system is in communication with an automated call distribution system and an agent database selects an agent to communicate with the user; and
providing information to the user based on an initial inquiry by the user.

2) The method of claim 1 further comprising the step of:
requiring the user to provide a personal identification number prior to communicating with the agent.

3) The method of claim 1 further comprising the step of:
providing a customer service representative wherein the customer service representative communicates live with the user prior to the input of data to the interactive voice response.

4) The method of claim 1 wherein the user connects to the call center system by a public switched telephone network, VPN, ISP, Direct Network or cellular network.

5) The method of claim 1 wherein the interactive voice response is connected to the agent qualifying and queuing system by a TCP/IP link.

6) The method of claim 1 further comprising the step of:
providing a custom script wherein the user provides information to the interactive voice response based on the custom script.

7) The method of claim 1 further comprising the step of:
providing an agent database wherein the agent database stores information regarding a plurality of agents of the call center system.

8) The method of claim 1 wherein the interactive voice response is connected to the agent qualifying and queuing system through a VPN, ISP, Direct network, or cellular network.

9) The method of claim 1 wherein the agent qualifying and queuing system is cached at different locations with real-time connection between at least two cache holding servers.

10) The method of claim 1 wherein the agent qualifying and queuing system is housed at various remote locations.

11) The method of claim 18 wherein the agent qualifying and queuing system at various remote locations communicate in real-time.

12) A method for selecting an agent in a call center system comprising:
providing an agent to respond to an inquiry from a user;
providing an interactive voice response system wherein the user connects to the interactive voice response system;
providing an agent qualifying and queuing system wherein an agent is selected to respond to the inquiry from the user based on a rating system based in part on the average satisfaction rating information of the agent obtained from previous users.

13) The method of claim 12 further comprising the step of:
increasing the likelihood that the agent will be chosen to respond to the user based in part on courses taken by the agent.

14) The method of claim 12 further comprising the step of:
increasing the likelihood that the agent will be chosen to respond to the user based in part on the expertise of the agent.

15) The method of claim 12 further comprising the step of:
increasing the likelihood that the agent will be chosen to respond to the user based in part on the time availability of the agent.

16) The method of claim 12 further comprising the step of:
increasing the likelihood that the agent will be chosen to respond to the user based in part on the consumer ratings.

17) The method of claim 12 further comprising the step of:
increasing the likelihood that the agent will be chosen to respond to the user based in part on the availability of agent to work with fixed or flexible schedule.

18) The method of claim 12 further comprising the step of:
increasing the likelihood that the agent will be chosen to respond to the user based in part on the bid price put in by the agent to service the call.

19) The method of claim 12 further comprising the step of:
increasing the likelihood that the agent will be chosen to respond to the user based in part on the average call time an agent may have taken historically to answer customer queries.
